(19) United States
(12) Patent Application Publication
(10) Pub. No.: US 2004/0066383 A1
(43) Pub. Date: Apr. 8, 2004

(54) Stereogram apparatus and operation method for the same

(76) Inventor: Shih Ping Chen, Taipei (TW)

Correspondence Address: BIRCH STEWART KOLASCH & BIRCH, PO BOX 747, FALLS CHURCH, VA, 22040-0747, US

(21) Appl. No.: 10/262,954

(22) Filed: Oct. 3, 2002

(51) Int. Cl. G06T 15/00; G02B 27/22

(52) U.S. Cl. 345/419; 359/462

(57) ABSTRACT

A stereogram apparatus comprises a digital imaging unit, a display unit, an input unit, a control unit and a printing unit. The digital imaging unit has a plurality of lens and the digital imaging unit is functioned to take a plurality of images into a plurality of graphic files. The input unit has a plurality of function keys. The display unit shows an operation screen and an image taken by the digital imaging unit. The control unit reads the plurality of graphic files and has a built-in software executing a processing to form a combinative graphic file with stereogram effect from the plurality of graphic files. The combinative graphic file is printed to form a composite plate for stereogram. The composite plate for stereogram is attached to a grating member with a predetermined angle to form an express photo with stereogram effect.

### FIELD OF THE INVENTION

The present invention relates to a stereogram apparatus and an operation method for the same, especially to a stereogram apparatus with multiple lens and an operation method for the same

### BACKGROUND OF THE INVENTION

Stereogram was well-known art and people could make stereogram in early time by using difference in depth of field for two eyes. Therefore, a stereogram can be made by using a camera to take picture at different locations for mimicking the action of eyes. Afterward, an auxiliary tool is used to render left eye and right eye with photographs taken at different locations to provide stereograph effect.

Moreover, commercially available stereogram cameras (such as those with $200 cost) employ four lens arranged alone a row and a plurality of lengthwise and separate images are formed on film. After the film is developed into photograph, a special layer is attached on the photograph to provide stereogram effect.

The currently popular express photo uses cameras such as digital still cameras to provide instant photo for user. However, the express stereogram is not available yet.

### SUMMARY OF THE INVENTION

It is the object of the present invention to provide a stereogram apparatus with multiple lens and an operation method for the same.

To achieve above object, the present invention provides a stereogram apparatus comprising a digital imaging unit, a display unit, an input unit, a control unit and a printing unit. The digital imaging unit has a plurality of lens and the digital imaging unit is functioned to take a plurality of images into a plurality of graphic files. The input unit has a plurality of function keys. The display unit shows an operation screen and an image taken by the digital imaging unit. The control unit reads the plurality of graphic files and has a built-in software executing a processing to form a combinative graphic file with stereogram effect from the plurality of graphic files. The combinative graphic file is printed to form a composite plate for stereogram. The composite plate for stereogram is attached to a grating member with a predetermined angle to form an express photo with stereogram effect.

To achieve above object, the present invention provides an operating method for a stereogram apparatus comprising following steps: starting up the stereogram apparatus; a digital imaging unit taking images in front of it and a display unit displaying the images in real time; the display unit displaying an interactive operation menu and a user using an input unit to select a desired background and a special effect; the user pressing an enter key and the digital imaging unit taking a plurality of images and the images being sent to the control unit; and a control unit having built-in software to form a combinative graphic file with stereogram effect.

The various objects and advantages of the present invention will be more readily understood from the following detailed description when read in conjunction with the appended drawing, in which:

### BRIEF DESCRIPTION OF DRAWINGS

FIG. 1 shows a block diagram of a stereogram apparatus according to a preferred embodiment present invention;

FIG. 2 shows a block diagram of a digital imaging unit; and

FIG. 3 shows a flowchart of the present invention.

### DETAILED DESCRIPTION OF THE INVENTION

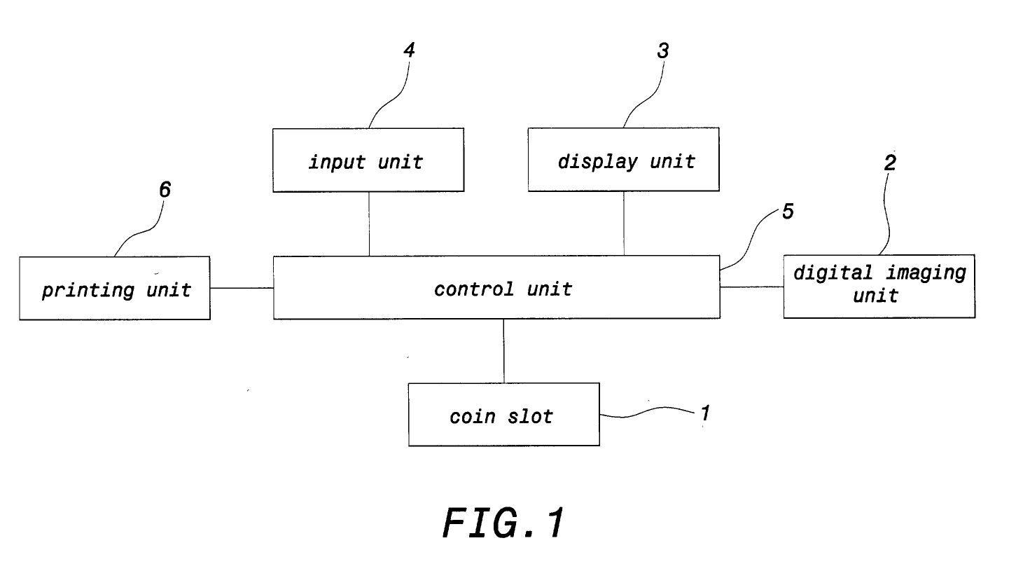

FIG. 1 shows a block diagram of a stereogram apparatus according to a preferred embodiment present invention. The stereogram apparatus comprises a coin slot 1, a digital imaging unit 2, a display unit 3, an input unit 4, a control unit 5 and a printing unit 6.

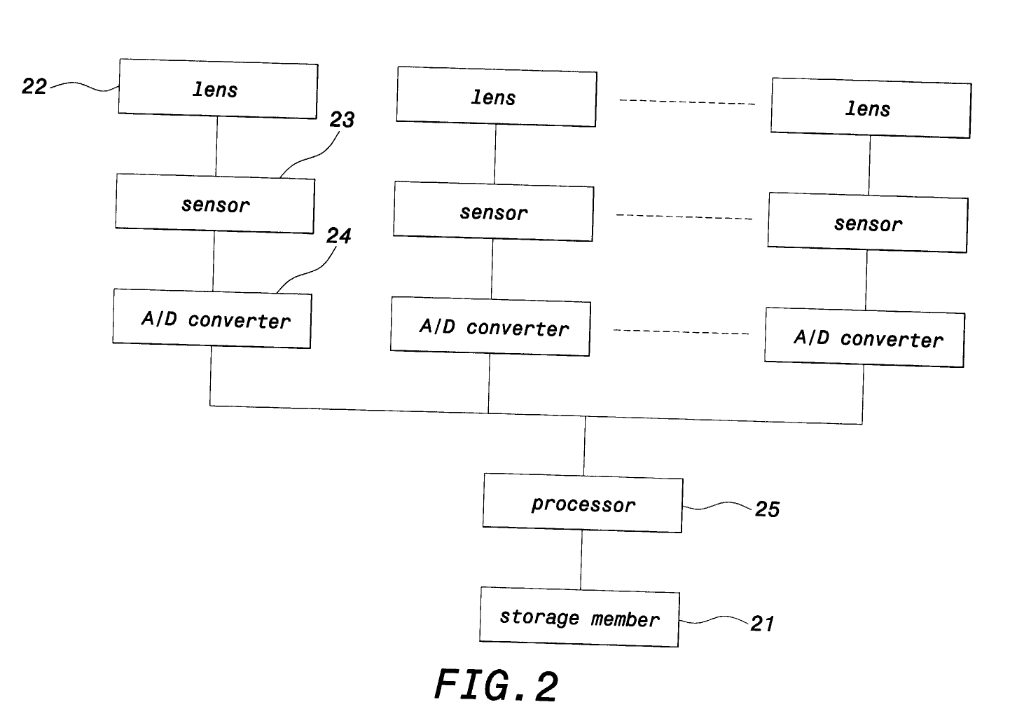

The digital imaging unit 2 is digital still camera (DSC) or digital video camera and has a block diagram shown in FIG. 2. The digital imaging unit 2 comprises a storage member 21, a plurality of lens 22, a plurality of sensors 23, a plurality of analog-to-digital (A/D) converters 24 and a processor 25. Each of the sensors 23 is connected to respective lens 22, and each of the A/D converters 24 is connected to respective sensor 23. The processor 25 is connected to the plurality of A/D converters 24 and the storage member 21.

The plurality of lens 22 are arranged in predetermined separations and inclined angles for guiding light of images to the sensors 23. The sensors 23 are, for example, charge-coupled device (CCD) or CMOS sensor and used to convert the light into analog electrical signals. The electrical signals are converted into digital counterpart by the A/D converters 24. The processor 25 processes the digital signals from the A/D converters 24 into a plurality of graphic files and stores the graphic files into the storage member 21.

With reference again to FIG. 1, the input unit 4 comprises a plurality of function keys including up arrow, down arrow and enter etc.

The display unit 3 is, for example, a liquid crystal display (LCD) and used to show operation screen and an image taken by the digital imaging unit 2.

The input unit 4 and the display unit 3, can be replaced by a touch panel providing both display and input function.

The control unit 5 is connected to the coin slot 1, the digital imaging unit 2, the display unit 3, the input unit 4 and the printing unit 6. The control unit 5 is functioned to control all the stereogram apparatus according to the present invention. The control unit 5 receives a plurality of images from the digital imaging unit 2 and has built-in software to process the plurality of images into a stereogram.

The printing unit 6 is, for example, a printer to print the stereogram.

The coin slot 1 can be replaced by a card reader.

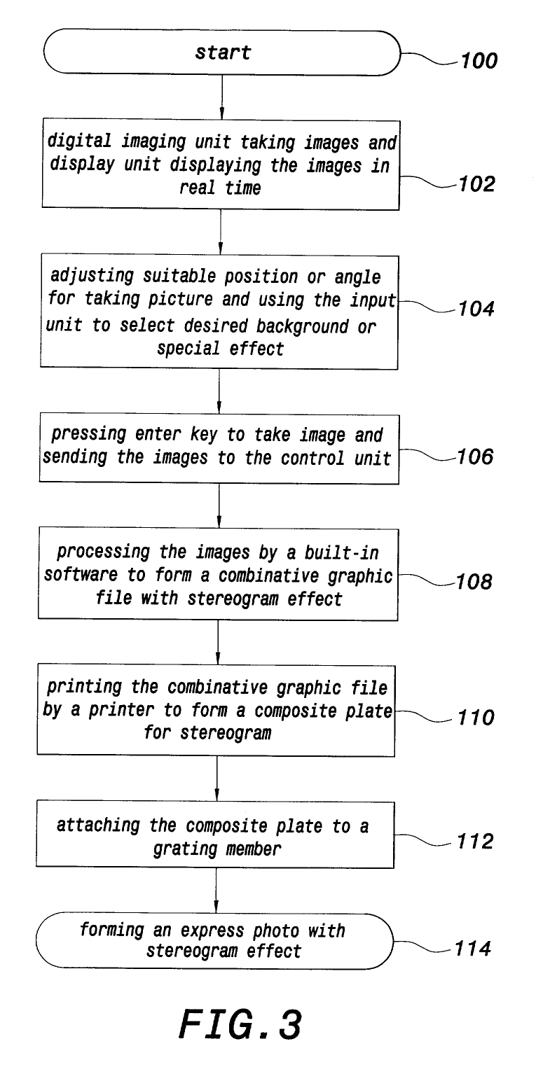

FIG. 3 shows a flowchart of the present invention. In step S100, a user inserts coin into the coin slot 1 of the stereogram apparatus to start up the stereogram apparatus. In step 102, the digital imaging unit 2 takes images in front of it and the display unit 3 displays the images in real time. Therefore, the user can adjust suitable position or angle for taking picture for him. In step S104, the display unit 3 displays interactive operation menu and the user can use the input unit 4 to select desired background or special effect. In step S106, the user can press an enter key and the digital imaging unit 2 takes a plurality of images and sends the images to the control unit. Afterward, the plurality of images are sent to the control unit 5. In step S108, the plurality of images are processed by a built-in software in the control unit 5 to form a combinative graphic file with stereogram effect. In step S110, the combinative graphic file is printed by the printing unit 6 to form a composite plate for stereogram. Afterward, in step S112, the composite plate for stereogram is attached to a grating member such as slit grating or prism grating with a predetermined angle to form an express photo with stereogram effect in step S114.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A stereogram apparatus, comprising
a digital imaging unit having a plurality of lens arranged in predetermined separations and inclined angles and the digital imaging unit functioned to take a plurality of images into a plurality of graphic files;
a display unit used to show an operation screen and an image taken by the digital imaging unit;
an input unit having a plurality of function keys;
a control unit connected to the digital imaging unit, the display unit, the input unit and the printing unit, the control unit being controlled by a command input from the input unit and reading the plurality of graphic files, the control unit having a built-in software, and the software executing a processing to form a combinative graphic file with stereogram effect from the plurality of graphic files; and
a printing unit to print the combinative graphic file into a composite plate for stereogram.

2. The stereogram apparatus as in claim 1, further comprising at least one of a coin slot and a card reader.

3. The stereogram apparatus as in claim 1, wherein the digital imaging unit is one of a digital still camera and a digital video camera.

4. The stereogram apparatus as in claim 1, wherein the digital imaging unit further comprising:
a storage member;
a plurality of sensors, each of the plurality of sensors being corresponding to one of the lens and producing an electrical signal from an optical signal passing through the lens;
a plurality of analog-to-digital (A/D) converters, each of the A/D converters being connected to one sensor and used to convert the electrical signal of the sensor into a digital signal; and
a processor connected to the storage member and the A/D converters and used to process the digital signal into a processed signal, the processed signal being stored in the storage member.

5. The stereogram apparatus as in claim 1, wherein the sensor is one of a charge-coupled device (CCD) and a CMOS sensor.

6. The stereogram apparatus as in claim 1, wherein the input unit and the control unit are replaced by a touch panel.

7. The stereogram apparatus as in claim 1, wherein the composite plate for stereogram is attached to a grating member with a predetermined angle to form an express photo with stereogram effect.

8. The stereogram apparatus as in claim 7, wherein the grating member is one of a slit grating and a prism grating.

9. An operating method for a stereogram apparatus, the stereogram apparatus having a digital imaging unit, a display unit, an input unit, a control unit, and a printing unit, the operating method comprising following steps:
(a) starting up the stereogram apparatus;
(b) the digital imaging unit taking images in front of it and the display unit displaying the images in real time;
(c) the display unit displaying an interactive operation menu and a user using the input unit to select a desired background and a special effect;
(d) the user pressing an enter key and the digital imaging unit taking a plurality of images and the images being sent to the control unit; and
(e) the control unit having built-in software to form a combinative graphic file with stereogram effect.

10. The operating method as in claim 9, further comprising a step after the step (e):
attaching the composite plate for stereogram to a grating member with a predetermined angle to form an express photo with stereogram effect, wherein the grating member is one of a slit grating and a prism grating.
